(19) United States
(12) Patent Application Publication
(10) Pub. No.: US 2010/0094073 A1
(43) Pub. Date: Apr. 15, 2010

(54) METHOD FOR TREATING WASTE PETROLEUM

(76) Inventor: Hong Yoon Choi, Busan (KR)

Correspondence Address: Hyun Jong Park;Park & Associates Intellectual Property Law LLC, Suite 106, 265 Bic Drive, Milford, CT, 06461, US

(21) Appl. No.: 12/571,334

(22) Filed: Sep. 30, 2009

Related U.S. Application Data
(63) Continuation of application No. PCT/KR2007/006800, filed on Dec. 24, 2007.

(30) Foreign Application Priority Data
Apr. 13, 2007 (KR) 10-2007-0036593

(51) Int. Cl. G21F 9/16

(52) U.S. Cl. 588/6

(57) ABSTRACT

The present invention relates to a method for treating various waste petroleum into eco-friendly solid that leaching of oil would not occur. The method of the present invention can treat radioactive waste petroleum used in a nuclear power station as well as various waste petroleum, thereby stabilizing waste petroleum chemically and physically, wherein the method comprises mixing waste petroleum with a concentrated sulfuric acid and a concentrated nitric acid; adding sodium hydroxide, thereby carrying out a second polymerization reaction to produce solid particles; colloidizing a mixture obtained by uniformly stirring the solid particles; adding a diisocyanate compound in reactor, thereby carrying out a third polymerization reaction to obtain a new compound in the form of powder; discharging a generated gas into the atmosphere; and filling the compound into a resin as a filling material and compression molding and reclaiming the filled compound.

### REFERENCE TO RELATED APPLICATIONS

This a continuation of pending International Patent Application PCT/KR2007/006800 filed on Dec. 24, 2007, which designates the United States and claims priority of Korean Patent Application No. 10-2007-0036593 filed on Apr. 13, 2007, the entire contents of which are incorporated herein by reference.

### FIELD OF THE INVENTION

The present invention relates to a method for treating waste petroleum, and more specifically relates to providing a method for treating various waste petroleum (such as a lubricating oil, a refrigerating oil, an insulating oil and the like used in general machinery and equipment as well as in particular radioactive waste petroleum) into eco-friendly solid to prevent an oil leaching from occurring.

### BACKGROUND OF THE INVENTION

Generally, various waste petroleum are classified into designated wastes under Wastes Control Act, and has been collected, and incinerated or purified into recovery oil by waste recovery companies.

Meanwhile, the waste petroleum used in nuclear power station, etc., has been separately treated in a radioactive waste treating facility to interrupt outflow of radioactive materials. Accordingly, various researches and developments to solidify radioactive waste oil permanently without an oil leaching has been carried out reiteratively and to store them permanently in a radioactive waste treating facility. As a result, there has been proposed a method for solidifying radioactive waste oil, in which radioactive waste petroleum is filled and fixed with cement with a ratio of 1:99. However, in the case of the method, it is impossible to prevent an oil leaching phenomenon that occurs within a few hours. Further, the conventional method does not eco-friendly treat waste petroleum and there are various difficult problems in relation to construction of a radioactive waste treating facility.

### SUMMARY OF THE INVENTION

It is an object of the present invention to provide a method for treating waste petroleum that can solve the various problems of the prior art as mentioned above.

To achieve the above objects, the present invention provides a method for treating waste petroleum comprising a series of steps as follows to treat the waste petroleum into eco-friendly solids.

That is, the inventors observed and analyzed properties of mixed radioactive waste petroleum in terms of various aspects, and developed a method for treating the waste petroleum in terms of a synthetic polymer by preceding a polymerization process. The present invention will be described in detail below. In an example of the present invention, radioactive waste petroleum was used as a sample.

The present invention provides a method for treating waste petroleum, which can treat waste petroleum eco-friendlily, and wherein the method comprises mixing waste petroleum with a concentrated sulfuric acid and a concentrated nitric acid; adding sodium hydroxide, thereby carrying out a second polymerization reaction to produce solid particles; colloidizing a mixture obtained by uniformly stirring the solid particles; adding a diisocyanate compound in reactor, thereby carrying out a third polymerization reaction to obtain a new compound in the form of powder; discharging a generated gas into the atmosphere; and filling the compound into a resin as a filling material and compression molding and reclaiming the filled compound.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a scheme and chemical formulas illustrating the method for treating waste petroleum of the present invention.

FIG. 2 through FIG. 4 are chemical formulas of various diisocyanates and triisocyanates used in the present invention.

FIG. 5 is a flow chart illustrating approximately the method for treating waste petroleum of the present invention.

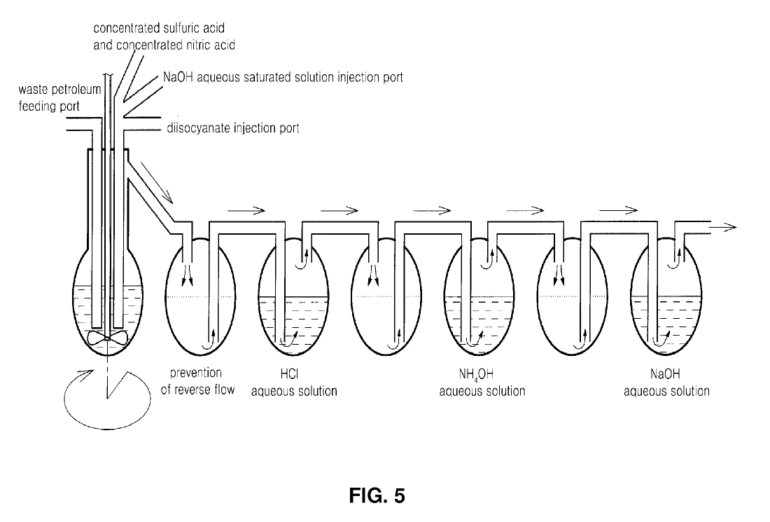

### DETAILED DESCRIPTION OF THE INVENTION

The present invention is described in detail as follows.

10-15% by weight of a mixture of a concentrated sulfuric acid (H₂SO₄) and a concentrated nitric acid (HNO₃) at a mixing ratio of 1:2 were mixed with 85-90% by weight of radioactive waste petroleum (R) used in a nuclear power station.

Since a modified waste petroleum (R′) and precipitates (R″) and filtrates (3H⁺³ and SO4⁻², NO₃⁻) were produced in the mixing step, an exothermic reaction occurred.

After mixing the precipitates (R″) with filtrates homogeneously, 10-15% by weight of a saturated aqueous sodium hydroxide solution (Na⁺OH⁻+H⁺₂O⁻²) was added to 85-90% by weight of a total amount of the mixture to cause second polymerization to produce small solid particles. If the solid particles are stirred uniformly to obtain a mixture, the mixture was colloidized like gruel.

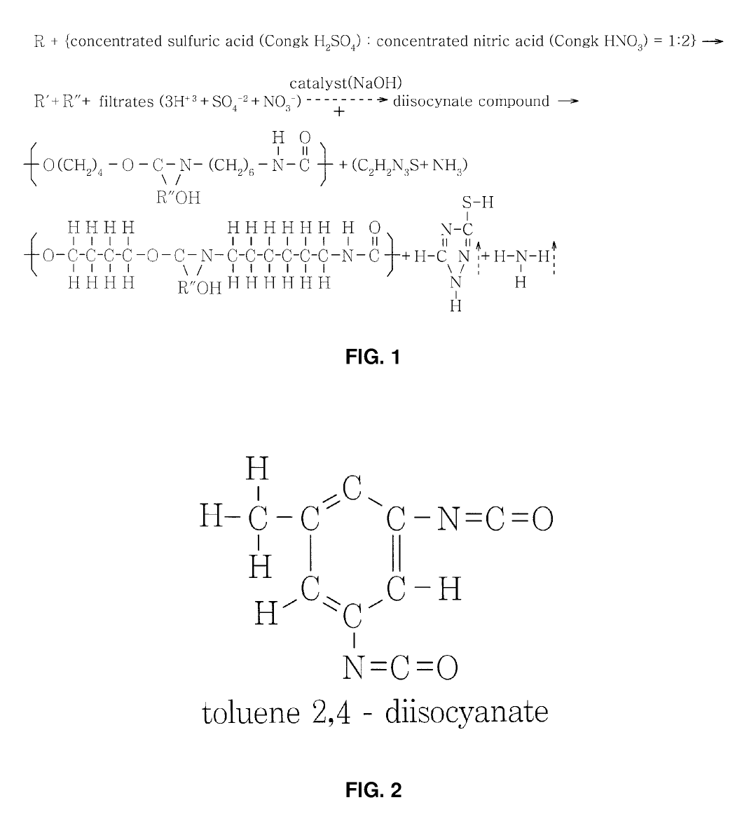

Before cooling of the reactor, i.e., under condition that an exothermic reaction is continued, 10-15% by weight of diisocyanate compound was added to 85-90% by weight of the stirred mixture to cause a series of a polymerization. As a result of the third polymerization, a new compound in the form of powders was produced and brown gas was generated. (See FIG. 1)

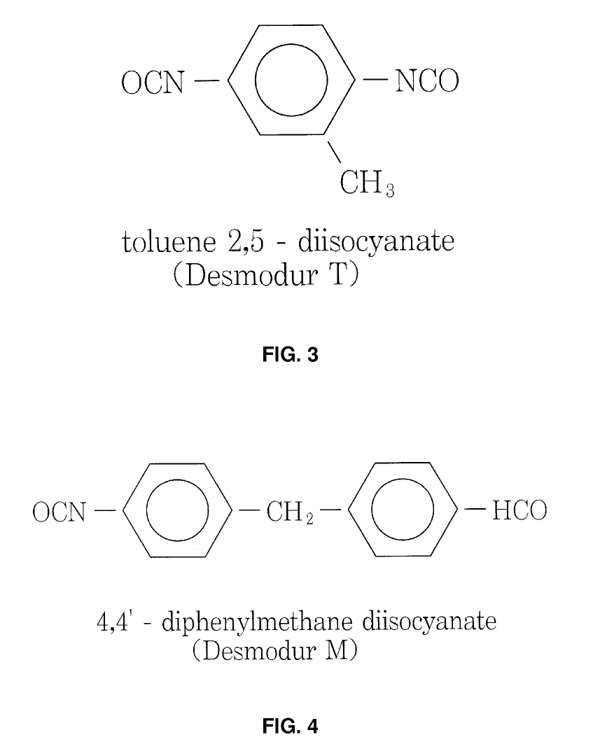

Many diisocyanates having various kinds of formula as depicted in FIG. 2 and FIG. 3 can be used selectively as the diisocyanate, and if appropriate a triisocyanate as depicted in FIG. 4 can be used.

And the brown gas was discharged to an atmosphere as an odorless gas after purification by way of three times of complex reactions.

Meanwhile, a compound produced as precipitates in a bottom of a reactor was a very stable brown composition in the form of powder that having odorless properties, refractory properties, water resistance, acid resistance and base resistance.

Since the brown composition is fine powders like a soil, and has a greater specific gravity than that of a water, the composition can be compression-molded (i.e., can be solidified or can be blocked) in a certain shape by adding the composition as filling material into an epoxy resin or an urea resin, a thermoplastic resin such as melamin. Accordingly, permanent reclamation of the wastes can be carried out readily. Further, the composition can be used as recycle materials such as basic materials for construction, and filling materials for asphalts that are produced by using the composition.

The concentrated sulfuric acid that was reacted with waste petroleum in the process can be replaced by hydrogen sulfide (H₂S) to carry out same reaction.

A new compound produced by treating waste petroleum does not carry out any ionization reaction with hydrochloric acid, nitric acid and the like because of its acid resistance and does not react in a strong base such as sodium hydroxide, potassium hydroxide and the like. Further, since the compound has refractory properties on firing, it did not cause a secondary environmental pollution.

It will be understood that the present invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying claims

### INDUSTRIAL APPLICABILITY

As described above, the method of the present invention can treat radioactive waste petroleum used in a nuclear power station as well as various waste petroleum, thereby stabilizing waste petroleum chemically and physically, wherein the method comprises mixing waste petroleum with a concentrated sulfuric acid and a concentrated nitric acid; adding sodium hydroxide, thereby carrying out a second polymerization reaction to produce solid particles; colloidizing a mixture obtained by uniformly stirring the solid particles; adding a diisocyanate compound in reactor, thereby carrying out a third polymerization reaction to obtain a new compound in the form of powder; discharging a generated gas into the atmosphere; and filling the compound into a resin as a filling material and compression molding and reclaiming the filled compound.

Further, a new compound produced by treating waste petroleum according to the present invention, can be compression-molded as block with various resins and can be reclaimed readily. Also, there are no problems caused by an oil leaching.

Accordingly, the present invention is excellent invention that can prevent secondary industrial pollutions caused by waste petroleum, specifically waste petroleum used in a nuclear power station.

What is claimed is:

1. A method for treating waste petroleum, comprising the following steps of:
(a) mixing 85-90% by weight of waste petroleum and 10-15% by weight of a mixed solution in which a concentrated sulfuric acid is mixed with a concentrated nitric acid at a mixing ratio of 1:2;
(b) producing precipitates and filtrates (3H⁺³ and SO4⁻², NO₃⁻) and modified waste petroleum obtained by the mixing step (a);
(c) adding 85-90% by weight of the mixed solution in which the precipitates and the filtrates are mixed homogeneously to 10-15% by weight of a saturated aqueous sodium hydroxide solution (Na⁺OH⁻+H⁺₂O⁻²), thereby carrying out a second polymerization reaction to produce solid particles;
(d) colloidizing a mixture obtained by uniformly stirring the solid particles
(e) adding 10-15% by weight of a diisocyanate compound to 85-90% by weight of the colloidized mixture before reactor cooling of the colloidized mixture, thereby carrying out a third polymerization reaction serially to obtain a mixture in the form of powder with a gas;
(f) purifying the gas generated in the third polymerization reaction and discharging the purified gas into the atmosphere by way of a complex salt reaction; and
(g) filling the compound into a resin as a filling material and compression molding and reclaiming the filled compound.
